(19) United States
(12) Patent Application Publication
(10) Pub. No.: US 2008/0089663 A1
(43) Pub. Date: Apr. 17, 2008

(54) APPARATUS AND METHOD FOR CONTROLLING AUTOMATIC RESERVED RECORDING IN BROADCASTING RECEIVING TERMINAL

(75) Inventors: Sun-Gi Lee, Seoul (KR); Kang-Hoon Lee, Yongin-si (KR); Cheong-Sun Lee, Suwon-si (KR); Hark-Soo Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/873,911

(22) Filed: Oct. 17, 2007

(30) Foreign Application Priority Data
Oct. 17, 2006 (KR) 101075/2006

(51) Int. Cl. H04N 5/91

(52) U.S. Cl. 386/83

(57) ABSTRACT

An apparatus and method for controlling automatic reserved recording in a broadcast-receiving terminal, in which a reserved recording function can be performed at accurate time based on a time difference between communication time for communication and broadcasting time, is provided. The apparatus includes a broadcasting part for receiving broadcasting program information and broadcasting and processing the received broadcasting, a memory unit for storing at least one of communication time information, broadcasting time information, time difference information, and guard time information for allowing a user to recheck reservation information prior to reserved recording time, a display unit, and a controller for periodically calculating and updating the broadcasting time by adding the time difference to the communication time upon user's setting of reserved recording for at least one broadcast, and controlling the broadcasting part to record the at least one broadcast when the broadcasting time is identical to the reserved recording time.

### PRIORITY

This application claims priority 35 U.S.C. § 119(a) to a Korean Patent Application filed in the Korean Intellectual Property Office on Oct. 17, 2006 and assigned Serial No. 2006-101075, the entire disclosure of which is hereby incorporated by reference.

### BACKGROUND OF THE INVENTION

1. Field of the Invention

The present invention relates to an apparatus and method for controlling automatic reserved recording in a broadcast-receiving terminal, and in particular, to an apparatus and method for controlling automatic reserved recording in order to allow broadcasting to be recorded at accurate reserved recording times.

2. Description of the Related Art

Generally, a broadcasting service is provided in the form of analog broadcasting or digital broadcasting. Recently, the broadcasting service has been provided mainly in the form of digital broadcasting. Digital broadcasting transmits a broadcasting signal, which has been conventionally transmitted in an analog manner, in a digital manner in order to provide superior quality and various services for both video and audio. A broadcast-receiving terminal capable of receiving the broadcasting service has a Personal Video Recorder (PVR) function for storing broadcasting contents. When the PVR function is activated by the receipt of a broadcasting signal, it allows the received broadcasting signal to be stored in a memory of the broadcast-receiving terminal. The PVR function also allows broadcasting received during watching as well as recording to be stored in the memory. As such, since a predetermined amount of broadcasting is continuously stored in the memory, the stored broadcasting can be output after the release of a pause, like in a Video Cassette Recorder (VCR) event for a live broadcasting program, thereby allowing a user to continuously watch the program.

Using the PVR function, the user can set recording or reserved recording for a particular broadcasting program. Generally, in a Digital Multimedia Broadcasting (DMB) system or a Digital Video Broadcasting-Handheld (DVB-H) system, broadcasting program information, such as an Electronic Program Guide (EPG) or an Electronic Service Guide (ESG), is provided to the broadcast-receiving terminal for a broadcasting service. The broadcast-receiving terminal then receives the provided broadcasting program information and displays the same on a screen in order to allow the user to selectively record or reserved-record a desired broadcasting program. If the user sets reserved recording for specific broadcasting content, the broadcast-receiving terminal turns off the power unless performing another function after setting the reserved recording, so as to prevent unnecessary power consumption caused by applying the power to devices for receiving broadcasting. At the reserved recording time, the broadcast-receiving terminal turns on the devices for receiving broadcasting in order to record the desired broadcasting content.

As such, the broadcast-receiving terminal needs to turn on the devices for receiving broadcasting at the accurate reserved recording time in order to record broadcasting content provided by a broadcasting server, and to turn off the devices at another time.

When the broadcast-receiving terminal is a Global System for Mobile Communications (GSM)/Global Packet Radio Service (GPRS) terminal, it is designed to display time information using an embedded Real Time Clock (RTC) unlike in a synchronous Code Division Multiplex Access (CDMA) terminal. Thus, for the GSM/GPRS terminal of an asynchronous mobile communication system, the user has to directly input time information. The user also has to reset the time information each time the turned-off GSM/GPRS terminal is turned on. As a result, time that is set by the user for communication may not be accurate time, causing a mismatch between the time for providing a broadcasting service from a broadcasting server and the time for communication. Hereinafter, the time for communication will be referred to as communication time and the time for providing a broadcasting service will be referred to as broadcasting time. The broadcast-receiving terminal can recognize the broadcasting time through broadcasting time information included in the received broadcasting program information. Since the broadcast-receiving terminal performs reserved recording according to the communication time, it may not perform reserved recording at the accurate broadcasting time when there is a mismatch between the communication time and the broadcasting time.

Moreover, when the broadcast-receiving terminal is a synchronous CDMA terminal of a synchronous mobile communication system, it receives time information from a base station and automatically sets time during a setup operation. Thus, the synchronous CDMA terminal maintains time corresponding to the time information received from the base station at all times without user's direct input of the time information. However, when the received time information is set during the setup operation, the set time information may differ slightly from terminal to terminal.

As described above, since the reserved recording time is based on the communication time of the broadcast-receiving terminal, the reserved recording may not be performed at the accurate reserved recording time in the case of a mismatch between the communication time and the broadcasting time. In other words, due to the mismatch, the broadcast-receiving terminal may turn on devices for receiving broadcasting before or after broadcasting content to be reserved-recorded is provided.

### SUMMARY OF THE INVENTION

An aspect of the present invention is to address at least the above problems and/or disadvantages and to provide at least the advantages described below. Accordingly, an aspect of the present invention is to provide an apparatus and method for controlling automatic reserved recording in order to allow broadcasting to be recorded at the accurate reserved recording time by correcting an error in time information between the time for communication, i.e., communication time and the time for providing broadcasting, i.e., broadcasting time, during reserved recording in a broadcast-receiving terminal.

According to one aspect of the present invention, there is provided an apparatus for controlling automatic reserved recording in a broadcast-receiving terminal. The apparatus includes a broadcasting part for receiving broadcasting program information and broadcasting and processing the received broadcasting, a memory unit for storing at least one of communication time information for communication, broadcasting time information for providing a broadcasting service, time difference information between communication time and broadcasting time, and guard time information for allowing a user to recheck reservation information prior to reserved recording time, a display unit for displaying input data, and a controller for periodically calculating and updating the broadcasting time by adding the time difference to the communication time upon the user's setting of reserved recording for at least one broadcast, and controlling the broadcasting part to record the at least one broadcast when the broadcasting time is identical to the reserved recording time.

According to another aspect of the present invention, there is provided a method for controlling automatic reserved recording in a broadcast-receiving terminal having a broadcasting part for receiving broadcasting program information, and broadcasting and processing the received broadcasting. The method includes, if a user sets reserved recording for at least one broadcast, storing communication time information for current communication, broadcasting time information for providing a broadcasting service, and time difference information between communication time and broadcasting time, periodically calculating and updating the broadcasting time by adding the time difference to the communication time, and controlling the broadcasting part to record the at least one broadcast when the broadcasting time is identical to reserved recording time.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 illustrates a broadcast-receiving terminal to which the present invention is applied;

FIG. 2 is a flowchart of a process of controlling automatic reserved recording based on a time difference between communication time and broadcasting time in a broadcast-receiving terminal according to an exemplary embodiment of the present invention; and

FIG. 3 illustrates an example for explaining the process of FIG. 2.

### DETAILED DESCRIPTION OF THE EXEMPLARY EMBODIMENT

The matters defined in the description such as a detailed construction and elements are provided to assist in a comprehensive understanding of an exemplary embodiment of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness. Throughout the drawings, the same drawing reference numerals will be understood to refer to the same elements, features and structures.

The present invention provides a method by which a broadcast-receiving terminal can perform a reserved recording function at the accurate reserved recording time based on a time difference between communication time for communication and broadcasting time provided through broadcasting reception. At this time, it is assumed that the broadcast-receiving terminal is set to perform reserved recording for particular broadcasting content and its broadcasting part enters a power saving mode if there is no further input for receiving broadcasting. The present invention also provides a method by which the broadcast-receiving terminal whose broadcasting part is in the power saving mode wakes up devices for receiving broadcasting at the accurate reserved recording time or at reservation information rechecking time that precedes the reserved recording time, in order to perform reserved recording.

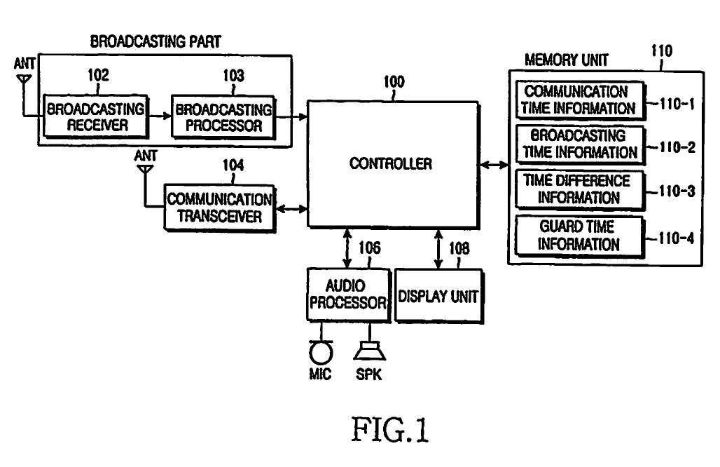

First, the configuration and operation of the broadcast-receiving terminal to which the present invention is applied will be described with reference to FIG. 1. In the present invention, the broadcast-receiving terminal has a mobile communication function and a portable broadcasting terminal function.

A broadcasting receiver 102 is a module for receiving a broadcasting signal provided from a broadcasting server, and receives a Radio Frequency (RF) signal of an Electronic Service Guide (ESG)/Electronic Program Guide (EPG) data stream and a data stream corresponding to a user-selected digital service through a Transport Stream (TS) of broadcasted digital broadcasting. A broadcasting processor 103 receives the RF signal received from the broadcasting receiver 102, demodulates digital data of a baseband signal, and provides the demodulated digital data to a controller 100. In the present invention, a communication transceiver 104 and the broadcasting processor 103 for receiving broadcasting program information and broadcasting and processing the received broadcasting will be referred to as a broadcasting part.

The communication transceiver 104 is a module for transmitting and receiving a signal for communicating with a communication system for a general terminal function, such as communication or message transmission, and low-noise amplifies the received RF signal and down-converts the frequency of the received RF signal.

An audio processor 106 converts an audio signal output from the controller 100 into an audible sound. A display unit 108 displays the current state and the operation state of the broadcast-receiving terminal under the control of the controller 100, and may be generally implemented with a Liquid Crystal Display (LCD) or an Organic Light Emitting Diode (OLED) display. A memory unit 110 stores data required for controlling the broadcast-receiving terminal. In particular, the memory unit 110 stores an ESG or an EPG, and also stores communication time information 110-1, broadcasting time information 110-2 provided for a broadcasting service, time difference information 110-3 between communication time and broadcasting time, and guard time information 1104 for allowing the user to re-check reservation information prior to the reserved recording time. A key input unit 112 receives a user manipulation signal, such as a key input, and transmits the same to the controller 100.

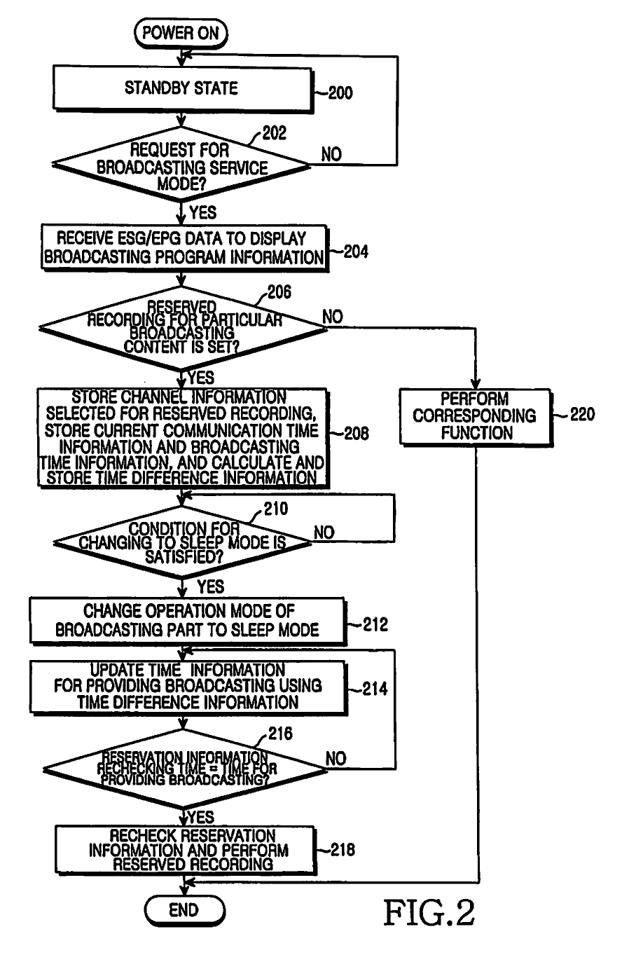

The controller 100 controls all components of the broadcast-receiving terminal for a broadcasting service. In particular, according to the present invention, once the user sets reserved recording for at least one broadcast, the controller 100 periodically calculates and updates the broadcasting time by adding the time difference to the communication time. The controller 100 then controls the broadcasting part to record the broadcast if the broadcasting time is identical to reserved recording time. If the broadcasting time is identical to reservation information rechecking time, the controller 100 receives broadcasting program information through the broadcasting part and displays information about the broadcast to be reserved-recorded through the display unit 108. The controller 100 checks if the broadcasting time is identical to the reserved recording time according to whether the user selects to continue recording as scheduled. If the broadcasting time is identical to the reserved recording time, the controller 100 controls the broadcasting part to record the broadcast. In addition, when the user sets reserved recording for at least one broadcast, the controller 100 stores the broadcasting time and communication time at a current time, and the time difference between the broadcasting time and the communication time, in the memory unit 110. Moreover, if a condition for changing the operation mode of the broadcasting part into a sleep mode is satisfied after the user sets reserved recording for at least one broadcast, the controller 100 changes the operation mode of the broadcasting part into the sleep mode in order not to provide the power to the broadcasting part. When the broadcasting part is in the sleep mode, the controller 100 provides the power to the broadcasting part to wake up the broadcasting part if the current broadcasting time is identical to the reservation information rechecking time. The detailed operation of the controller 100 will be described in more detail with reference to FIG. 2.

If the broadcast-receiving terminal changes the operation mode of the broadcasting part to the sleep mode for power saving after setting reserved recording for particular broadcasting content because there is no further operation for a broadcasting service, it wakes up the broadcasting part in operation at the accurate reserved recording time according to error time between communication time and broadcasting time. Thus, in spite of an error between the communication time and the broadcasting time, broadcasting content to be reserved-recorded can be recorded at the accurate reserved recording time provided by a broadcasting server.

Hereinafter, a process for recording broadcasting content to be reserved-recorded at accurate reserved recording time based on a time difference between communication time and broadcasting time will be described with reference to FIG. 2.

First, once the broadcast-receiving terminal is power on, the power is applied to devices for communication, such as the controller 100 and the communication transceiver 104.

The controller 100 maintains a standby state in step 200. If a request for a broadcasting service mode is input by the user in step 202, the controller 100 goes to step 204. In step 204, the controller 100 applies the power to the broadcasting receiver 102 and the broadcasting processor 103 for performing the broadcasting service mode, receives ESG/EPG data, and outputs broadcasting program information to the display unit 108.

In step 206, the controller 100 checks if a request for setting reserved recording for a particular broadcasting content is input by the user. If so, the controller 100 goes to step 208. If not, the controller 100 goes to step 220.

In step 208, the controller 100 stores channel information that is selected by the user for reserved recording in the memory unit 110. The controller 100 then stores communication time and broadcasting time at the reserved recording time and calculates a time difference between the communication time and the broadcasting time. The controller 100 then stores the calculated time difference in the memory unit 110 and goes to step 210.

After reserved recording for particular broadcasting content is set, the controller 100 checks if the current state satisfies a condition for changing the broadcasting part to the sleep mode in step 210. At this time, the condition may be that there is no predetermined operation for a broadcasting service during a preset amount of time after reserved recording for particular broadcasting content is set.

If the current state satisfies the condition in step 210, the controller 100 changes the operation mode of the broadcasting part to the sleep mode in step 212. Thereafter, the controller 100 periodically updates time information for providing broadcasting content for which reserved recording is actually set, based on the time difference in step 214. For example, if the time at which reserved-recording set broadcasting content is provided from a broadcasting server is 5:00 p.m., communication time and broadcasting time at the reserved recording setting time are 8:55 a.m. and 9:00 a.m., respectively, the time difference between the communication time and the broadcasting time is 5 minutes. Since an operation in the broadcast-receiving terminal is controlled based on the communication time, the broadcast-receiving terminal performs an operation for recording the broadcasting content when the communication time is 5:00 p.m. However, due to the time difference of 5 minutes between the communication time and the broadcasting time, if recording is started at the communication time, e.g., 5:00 .m., the broadcasting time at the communication time is 5:05 p.m.; 5 minutes behind the time at which the broadcasting content is provided from the broadcasting server. Thus, according to the present invention, the communication time to which a time difference of 5 minutes checked at the reserved recording setting time is added is used as the broadcasting time, and the broadcasting time is periodically updated.

Thereafter, the broadcasting part in the power saving mode is woken up for reserved recording at the broadcasting time. In other words, broadcasting content is recorded at the broadcasting time of 5:05 PM. Instead of at the communication time of 5:00 PM, thereby performing recording at the accurate time at which the broadcasting content is provided from the broadcasting server.

In step 216, the controller 100 checks if the broadcasting time is identical to the reservation information rechecking time. The reservation information rechecking time allows the user to recheck reserved broadcasting information prior to a guard time that precedes the set reserved recording time. The guard time may be set based on the amount of time for turning on the broadcast-receiver 102, the amount of time required for performing a process for displaying broadcasting information on a screen such as the amount of time required for receiving an ESG/EPG, and the amount of time required for the user to check reservation information before reserved recording.

In step 216, the controller 100 also checks if the current broadcasting time is identical to the reservation information rechecking time.

If so, the controller 100 rechecks the reservation information and performs reserved recording according to the rechecking operation in step 218. More specifically, in step 218, the controller 100 wakes up the broadcasting part including the broadcasting receiver 102 and the broadcasting processor 103 from the sleep mode by providing the power to the broadcasting part if the current broadcasting time is identical to the reservation information rechecking time. The controller 100 can perform the control operation using a control path in such a way as to wake up the broadcasting part by applying the power to power source terminals of all devices of the broadcasting part. The awoken broadcasting receiver 102 receives the ESG/EPG data from the broadcasting server. The controller 100 then checks if the reserved-recording set broadcasting content is to be serviced by checking the received ESG/EPG data. If so, a message for checking if the user desires to continue recording as scheduled is displayed to the user through the display unit 108. If the user checks the displayed message and then inputs data for continuing reserved recording, the controller 100 records the broadcasting content when the broadcasting time is identical to the set reserved recording time.

However, if the user inputs data for canceling reserved recording, the controller 100 releases the setting of reserved recording.

As a result of checking if the reserved-recording set broadcasting content is to be serviced by checking the received ESG/EPG data, if the reserved-recording set broadcasting content is not serviced, a message for checking if the user desires to make a change to reserved recording is displayed to the user through the display unit 108.

If any further information corresponding to user's checking is not input from the user, recording is performed as originally reserved after a predetermined amount of time.

During the reserved recording of the particular broadcasting content, if the user inputs a request for watching the broadcasting content that is being recorded, the controller 100 outputs the broadcasting content stored in the memory unit 110 from the start through the display unit 108 while continuously recording the broadcasting content. By doing so, the user can watch the broadcasting content with a predetermined time interval during recording of the broadcasting content.

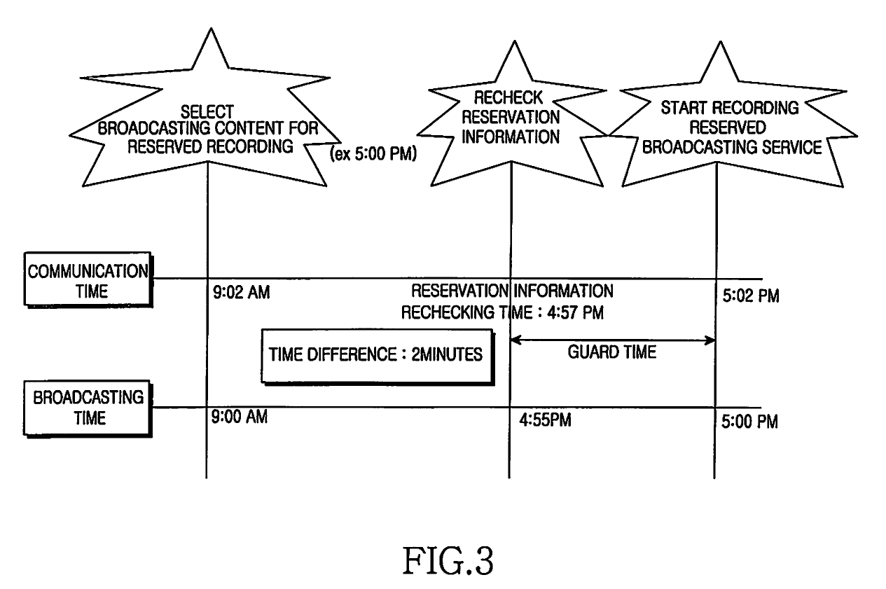

Hereinafter, the process of FIG. 2 will be described through an example illustrated in FIG. 3.

It is assumed that the communication time at the time at which the user makes a selection for reserved recording of particular broadcasting content is 9:02 PM and the broadcasting time at that time is 9:00 AM. The assumption is also made that the user-selected broadcasting content is provided from the broadcasting server at 5:00 PM and a guard time is 5 minutes.

The broadcast-receiving terminal then stores the communication time and the broadcasting time at the reserved recording setting time and calculates a time difference between the communication time and the broadcasting time. According to the assumption, the calculated time difference is 2 minutes. If there is no further operation for a broadcasting service, the broadcast-receiving terminal controls a broadcasting module to operate in the sleep mode and periodically updates the broadcasting time acquired by adding the time difference to the communication time. When the current broadcasting time is identical to the reservation information rechecking time, i.e., 04:55 PM., the broadcasting module is woken up to recheck reservation. If the current broadcasting time is 04:55 PM, the communication time is 04:57 PM. In this case, if the guard time for waking up the broadcasting part is set to 5 minutes, the actual communication time indicates 04:57 PM, even though the broadcasting time is 4:55 PM. The broadcasting part is woken up at the communication time of 04:57 PM. According to the present invention, an operation for communication in a broadcast-receiving terminal is performed at the corresponding time based on the communication time, but an operation for reserved recording by waking up the broadcasting module during reserved recording setting is performed based on the broadcasting time instead of the communication time. As such, according to the present invention, the broadcast-receiving terminal performs reserved recording based on the broadcasting time, thereby allowing the user to check the accurate time at which broadcasting content to be recorded is provided from the broadcasting server and controlling the power saving mode of the broadcasting part at the accurate time.

As described above, according to the present invention, when a broadcast-receiving terminal sets reserved recording for particular content, it acquires accurate time information for reserved recording and controls the sleep mode of a broadcasting part for reserved recording while maintaining low power consumption. Thus, instead of performing reserved recording based on random communication time for general reservation operations, the accurate time at which the broadcasting content is provided from the broadcasting server can be checked based on time information, in which a time difference between broadcasting time and communication time is corrected, and the broadcasting content can be recorded at the accurate reserved recording time. Moreover, by providing broadcasting information to be reserved-recorded to the user prior to actual reserved recording, the broadcast-receiving terminal can enable the user to select whether to continue reserved recording, thereby providing user convenience and allowing user selection.

While the invention has been shown and described with reference to an exemplary embodiment thereof, it will be understood by those skilled in the art that various changes in form and details may be made therein without departing from the spirit and scope of the invention.

What is claimed is:

1. An apparatus for controlling automatic reserved recording in a broadcast-receiving terminal, the apparatus comprising:
a broadcasting part for receiving broadcasting program information and at least one broadcast and processing the received broadcast;
a memory unit for storing guard time information for rechecking reservation information;
a display unit for displaying input data; and
a controller for periodically calculating and updating a broadcasting time by adding a time difference to a communication time upon a user's setting of reserved recording for at least one broadcast, and controlling the broadcasting part to record the at least one broadcast when the broadcasting time is identical to a reserved recording time.

2. The apparatus of claim 1, wherein if the broadcasting time is identical to a reservation information rechecking time, the controller receives the broadcasting program information through the broadcasting part to display information about the at least one broadcast to be reserved-recorded through the display unit, checks whether the broadcasting time is identical to the reserved recording time according to whether the user selects to continue reserved recording, and controls the broadcasting part to record the at least one broadcast when the broadcasting time is identical to the reserved recording time.

3. The apparatus of claim 2, wherein if the user sets reserved recording for the at least one broadcast, the controller stores the broadcasting time and the communication time at a current time in the memory unit and stores the time difference between the broadcasting time and the communication time in the memory unit.

4. The apparatus of claim 2, wherein if a condition for changing an operation mode of the broadcasting part to a sleep mode is satisfied after the user's setting of reserved recording for the at least one broadcast, the controller changes the operation mode of the broadcasting part to the sleep mode in order to not provide power to the broadcasting part.

5. The apparatus of claim 4, wherein the controller wakes up the broadcasting part from the sleep mode by applying the power to the broadcasting part if a current broadcasting time is identical to the reservation information rechecking time.

6. The apparatus of claim 2, wherein a guard time is set based on at least one of an amount of time required for turning on the broadcasting part, an amount of time required for receiving the broadcasting program information, and an amount of time required for the user to check reservation information.

7. The apparatus of claim 4, wherein the condition for changing the operation mode of the broadcasting part to sleep mode is that there is no predetermined operation for a broadcasting service during a preset amount of time after the user's setting of reserved recording for the at least one broadcast.

8. A method for controlling automatic reserved recording in a broadcast-receiving terminal having a broadcasting part for receiving broadcasting program information and a broadcast and processing the received broadcast, the method comprising:
if a user sets reserved recording for at least one broadcast, storing communication time information for current communication, broadcasting time information for providing a broadcasting service, and time difference information between a communication time and a broadcasting time;
periodically calculating and updating the broadcasting time by adding a time difference to the communication time; and
controlling the broadcasting part to record the at least one broadcast when the broadcasting time is identical to a reserved recording time.

9. The method of claim 8, further comprising:
storing a guard time for calculating a reservation information rechecking time for informing a user of reserved broadcasting content information prior to the reserved recording time;
if the broadcasting time is identical to the reservation information rechecking time, receiving broadcasting program information through the broadcasting part to display information about the at least one broadcast to be reserved-recorded on a screen;
checking if the broadcasting time is identical to the reserved recording time according to whether the user selects to continue reserved recording; and
controlling the broadcasting part to record the at least one broadcast when the broadcasting time is identical to the reserved recording time.

10. The method of claim 9, further comprising:
if the user sets reserved recording for the at least one broadcast,
storing the broadcasting time and the communication time at a current time; and
storing a time difference between the broadcasting time and the communication time.

11. The method of claim 9, further comprising:
if a condition for changing an operation mode of the broadcasting part to a sleep mode is satisfied after user's setting of reserved recording for the at least one broadcast,
changing the operation mode of the broadcasting part to the sleep mode in order to not provide the power to the broadcasting part.

12. The method of claim 11, further comprising:
if the current broadcasting time is identical to the reservation information rechecking time, waking up the broadcasting part from the sleep mode by applying power to the broadcasting part.

13. The method of claim 9, wherein the guard time is set based on at least one of an amount of time required for turning on the broadcasting part, an amount of time required for receiving the broadcasting program information, and an amount of time required for the user to check reservation information before reserved recording.

14. The method of claim 11, wherein the condition for changing the operation mode of the broadcasting part to the sleep mode is that there is no predetermined operation for the broadcasting service during a preset amount of time after user's setting of reserved recording for the at least one broadcast.
